(19) United States
(12) Patent Application Publication
(10) Pub. No.: US 2016/0040800 A1
(43) Pub. Date: Feb. 11, 2016

(54) VALVE ASSEMBLY

(71) Applicant: GOSCO SKUNKWORKS LTD., Oakville (CA)

(72) Inventors: Thomas Mark GOSLING, Kitchener (CA); Steven Victor KAKNEVICIUS, Victoria (AU)

(21) Appl. No.: 14/453,186

(22) Filed: Aug. 6, 2014

(51) Int. Cl. F16K 27/08

(52) U.S. Cl. CPC F16K 27/08

(57) ABSTRACT

A valve assembly for controlling flow of a fluid therethrough, including a first flange and a second flange, and two or more plates positioned between the first flange and the second flange. Each plate includes a plate body with an inner edge at least partially defining a part of a central opening therein. The plate body includes a number of apertures therein for receiving respective portions of a plurality of flange fastening elements to secure the plate bodies together between the first flange and the second flange to substantially align the respective inner edges thereof, so that the plate bodies substantially define the central opening therethrough. The valve assembly also includes a core element defining a central bore therein through which the fluid is at least partially flowable, the core element being formed to at least partially fit in the central opening.

### FIELD OF THE INVENTION

The present invention is a valve assembly for controlling flow of a fluid therethrough.

### BACKGROUND OF THE INVENTION

As is well known in the art, a valve body typically includes tapped holes to accommodate a bonnet and flange bolting. Typical elements of the prior art valves are illustrated in FIGS. 1A-1C. (As will be described, the remainder of the drawings illustrate the present invention.)

A typical valve 10 is illustrated in FIG. 1A. The valve 10 includes a bonnet 12 that is bolted directly to a body 14 with bolts or studs 16. For example, as can be seen in FIG. 1A, in a conventional arrangement, six studs 16 extend directly through the bonnet 12 via bonnet holes 17 (FIG. 1C) and into the body 14, so that when tightened they compress a bonnet gasket (not shown) positioned between the bonnet and the body, to create a substantially fluid-tight seal between the body and the bonnet.

As can be seen in FIG. 1A, the valve 10 also includes flanges 18, 20 between which the body 14 is held. The flanges typically include through-holes (not shown) so that bolts or studs 22 may extend through the through-holes into tapped holes 24 (FIG. 1B), and the body 14 may be secured thereby between the flanges 18, 20.

The valve 10 shown in FIGS. 1A-1C represents a typical design including a bolted-on bonnet. This design is often used, for instance, with complicated packing and gland arrangements. The bolts or studs 16 typically are inserted through the bonnet holes 17 into tapped holes 26 in the body 14. The conventional body 14 is shown in FIG. 1B.

There are a number of disadvantages to this design. For example, because the body 14 includes the tapped holes 24 and the tapped holes 26 for partially receiving the bolts or studs 22 and also for partially receiving the bolts 16 securing the bonnet 12 to the body 14 respectively, the body 14 has outer dimensions that are relatively large, in view of the diameters of bores “B₁”, “B₂” therethrough. In this design, the body 14 is required to be relatively large in order to provide sufficient material around the tapped holes 24, 26 to maintain the body's structural integrity.

In addition, and for the same reason, the bonnet 12 is required to be relatively large to accommodate the bonnet holes 17 and also tapped holes 27 (FIG. 1C). In some designs, the bonnet 12 may need to be sufficiently large that additional holes (e.g., to accept fasteners for an actuator or a gearbox bracket) are accommodated.

For example, as can be seen in FIG. 1A, the bonnet 12 typically includes the through holes 17 (FIG. 1C) in which fasteners “F” are receivable, for securing a gland plate 28 around an actuator 29.

In practice, the wall thicknesses of the prior art bodies 14 and bonnets 12 are generally far larger than the minimum wall thicknesses that are required by the applicable codes (e.g., ANSI). The relatively large conventional body 14, and the relatively large conventional bonnet 12, result in significant costs due to the relatively large amount of material required therefore and the relatively large amount of machining required.

The conventional approach to this problem is to have bolting (i.e., connecting the flanges, and holding the body therebetween) located externally of the body (not shown). In this alternative known version, the bonnet is omitted. The stem (or actuator) is inserted into the valve from the inside, and the stem packing is contained in a stem cavity that is machined inside the body. A stem guide is also required to be positioned in the stem cavity in the body. However, although the body can be smaller in this design, the body is still required to be sufficiently large to accommodate the stem packing and the stem guide. In addition, the alternate design does not readily accommodate alternate bonnet arrangements, e.g., multiple packing sets or an extended bonnet, for service in very hot conditions.

### SUMMARY OF THE INVENTION

There is a need for a valve assembly that overcomes or mitigates one or more of the disadvantages or defects of the prior art. Such disadvantages or defects are not necessarily included in those listed above.

In its broad aspect, the invention provides a valve assembly for controlling flow of a fluid therethrough. The valve assembly includes a first flange and a second flange, and two or more plates positioned between the first flange and the second flange. Each plate includes a plate body with an inner edge at least partially defining a part of a central opening therein. The plate body includes a number of apertures therein for receiving respective portions of a plurality of flange fastening elements to secure the plate bodies together between the first flange and the second flange to substantially align the respective inner edges thereof, so that the plate bodies substantially define the central opening therethrough. The valve assembly also includes a core element defining a central bore therein through which the fluid is at least partially flowable, the core element being formed to at least partially fit in the central opening.

In another aspect, the invention provides a method of assembling a valve assembly for controlling flow of a fluid therethrough. The method includes providing a first flange and a second flange, and providing two or more plates. Each plate includes a plate body with an inner edge at least partially defining a part of a central opening in the plate body. The plate body includes a number of apertures therein for receiving respective portions of a plurality of flange fastening elements to secure the plate bodies together between the first flange and the second flange to substantially align the respective inner edges thereof, so that the plate bodies substantially define the central opening therethrough. The plates are positioned between the first and second flanges. The apertures in the plate bodies are aligned and the inner edges thereof are aligned to at least partially define the central opening. A core element sized to fit at least partially in the central opening is provided, the core element defining a bore therein through which the fluid is flowable. The core element is positioned substantially in the central opening. The fastening elements are used to secure the plate bodies between the first and second flanges.

### BRIEF DESCRIPTION OF THE DRAWINGS

The invention will be better understood with reference to the attached drawings, in which:

FIG. 1A (also described previously) is an isometric view of a valve of the prior art;

FIG. 1B (also described previously) is an isometric view of a conventional body of the valve of FIG. 1A, drawn at a larger scale;

FIG. 1C (also described previously) is an isometric view of a conventional bonnet of the valve of FIG. 1A;

FIG. 2A is an isometric view of an embodiment of a valve assembly of the invention including plates, drawn at a smaller scale;

FIG. 2B is an isometric view of the valve assembly of FIG. 2A with the plates omitted;

FIG. 3 is an exploded view of an alternative embodiment of the valve assembly of the invention, drawn at a smaller scale;

FIG. 4A is a cross-section of the valve assembly of FIG. 2A, drawn at a larger scale;

FIG. 4B is an isometric view of an embodiment of a core element of the invention, drawn at a larger scale;

FIG. 4C is an isometric view of an embodiment of a bonnet adaptor of the invention;

FIG. 5A is an isometric view of the valve assembly of FIG. 2A, with the flanges and flange fastening elements omitted, drawn at a smaller scale;

FIG. 5B is an end view of the plates and bonnet of FIG. 5A;

FIG. 5C is an isometric view of one of the plates of FIGS. 5A and 5B;

FIG. 5D is an isometric view of the bonnet plate of FIGS. 5A and 5B;

FIG. 6A is a partially exploded view of an alternative embodiment of the valve assembly of the invention;

FIG. 6B is a partially exploded view of another embodiment of the valve assembly of the invention; and

FIG. 6C is an end view of an embodiment of the plate of the invention, drawn at a larger scale.

### DETAILED DESCRIPTION

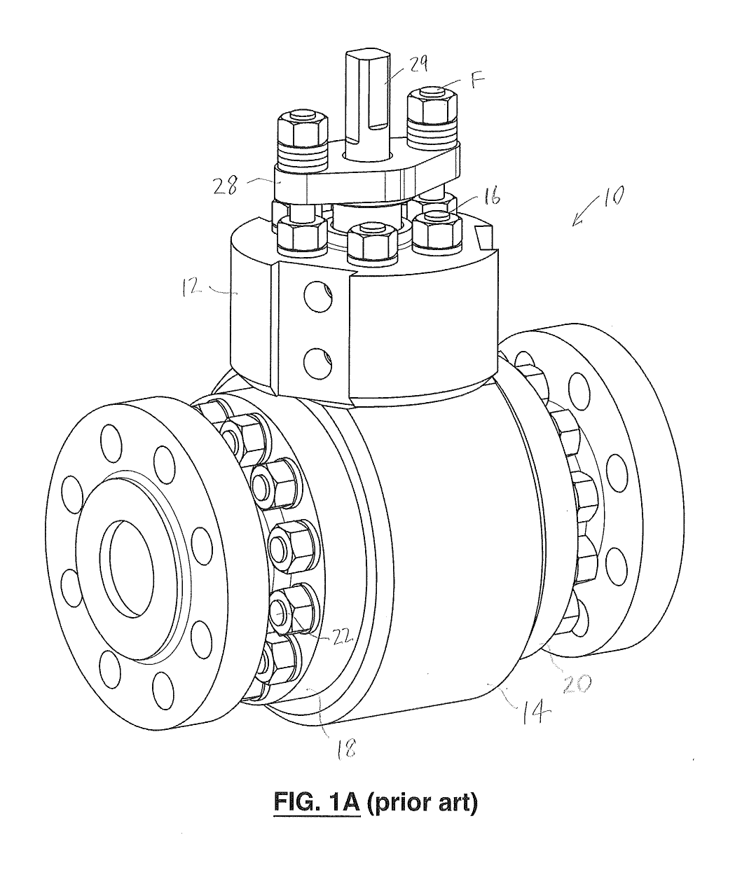

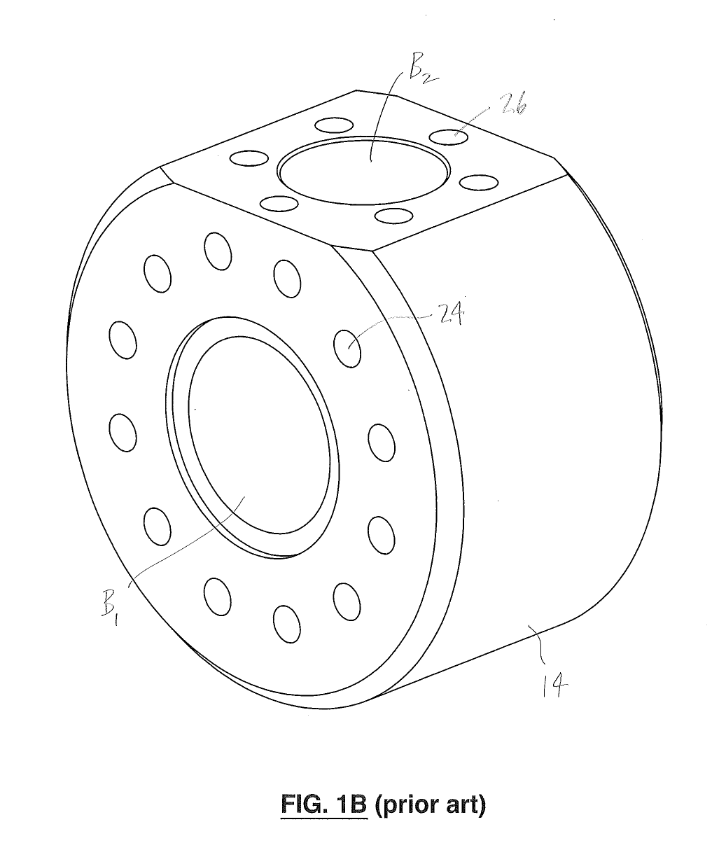

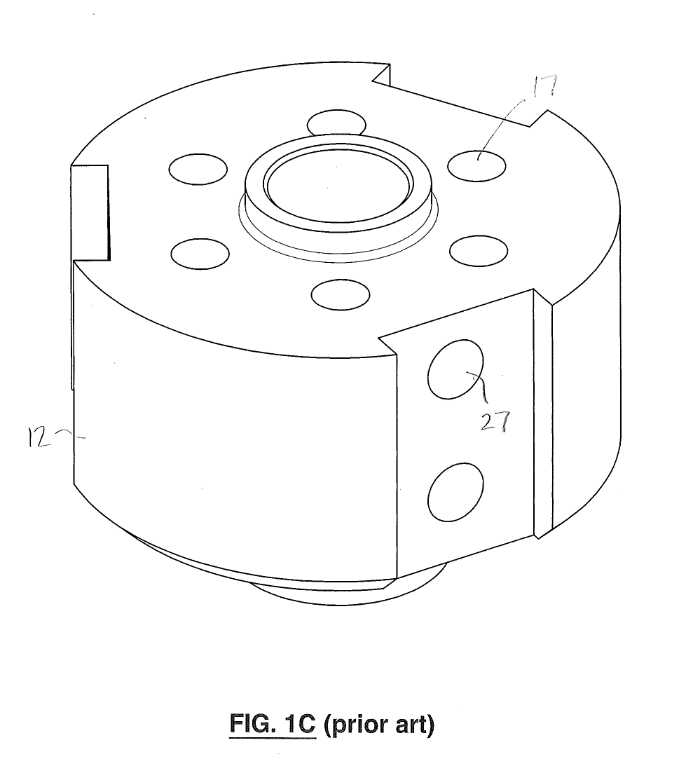

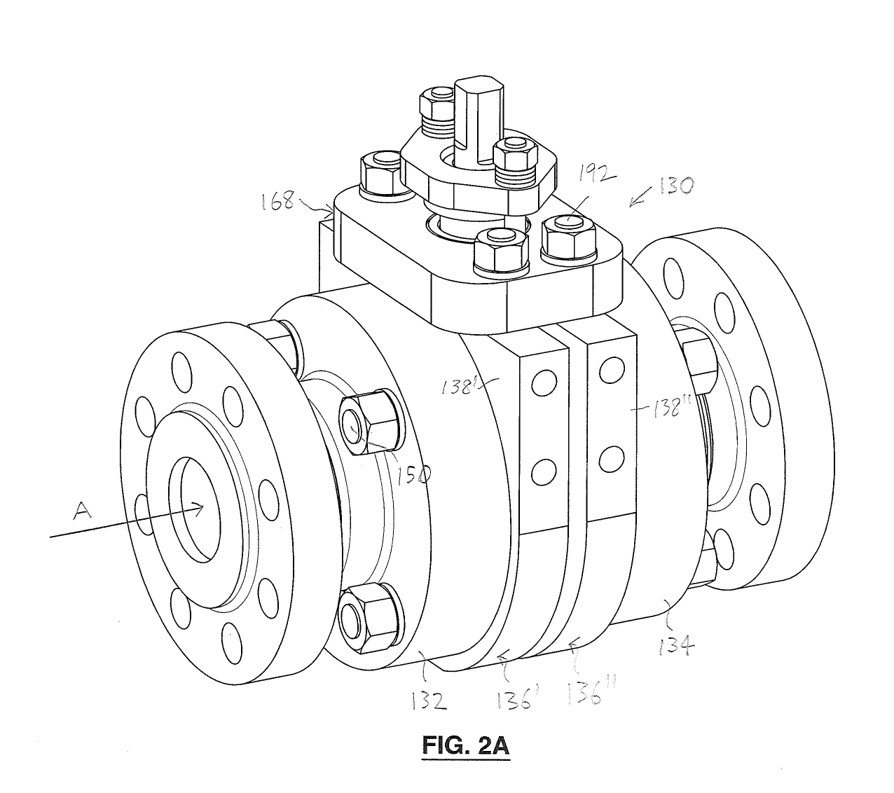

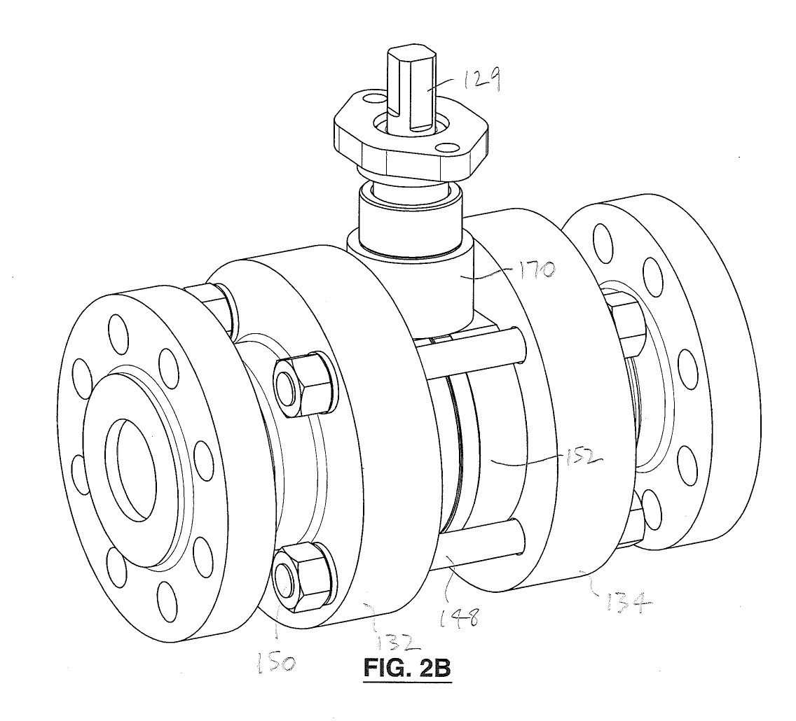

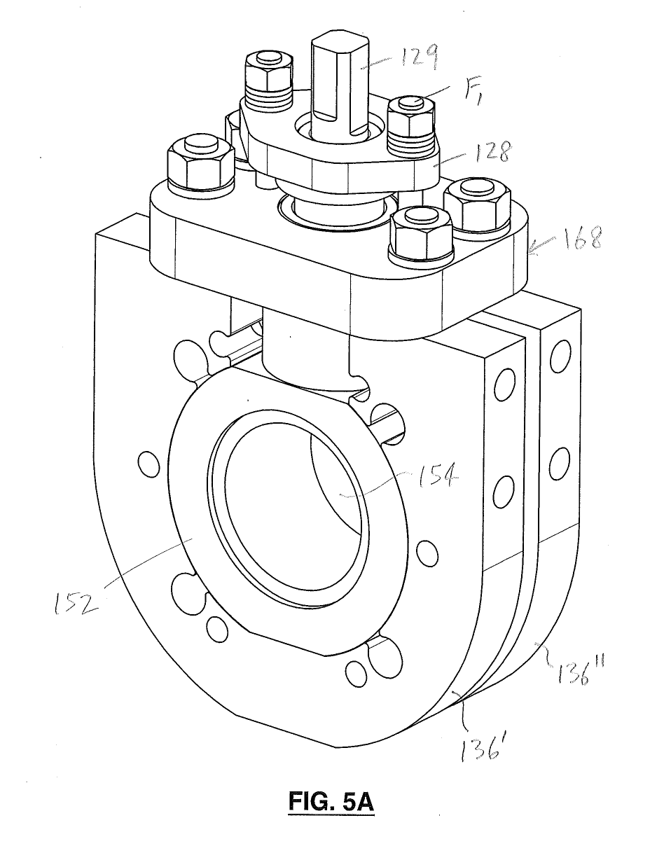

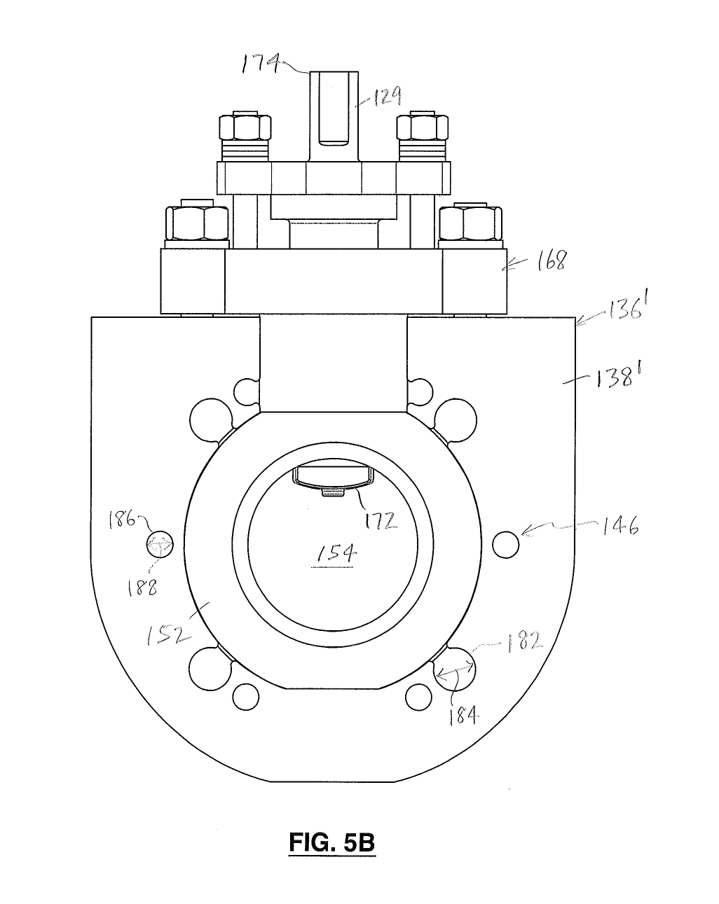

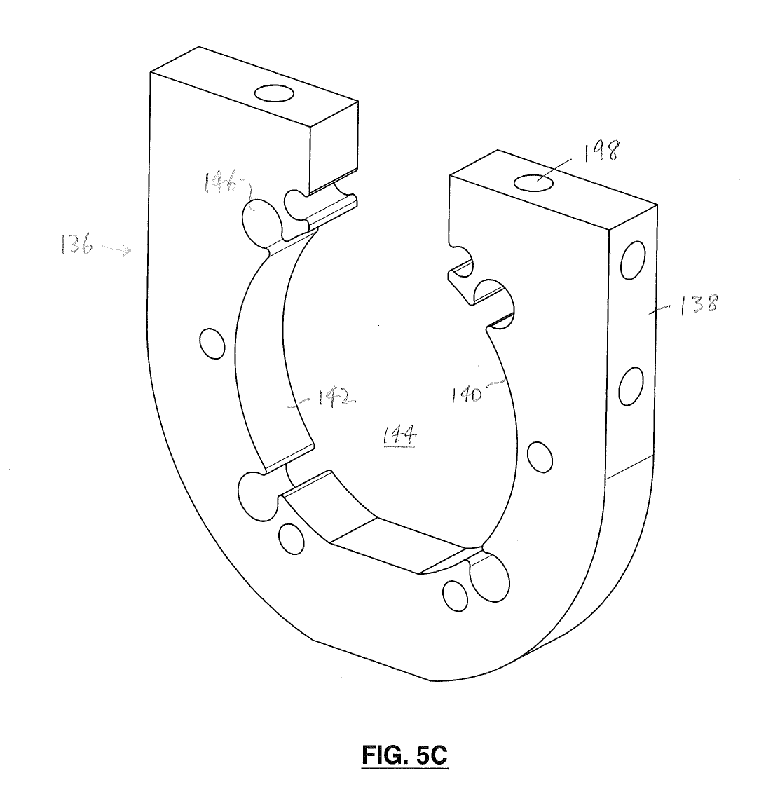

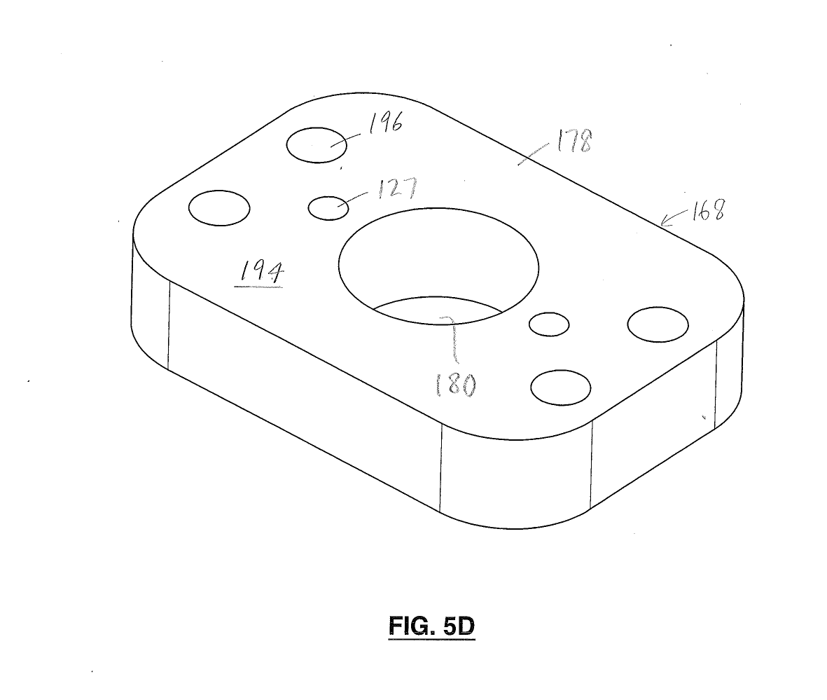

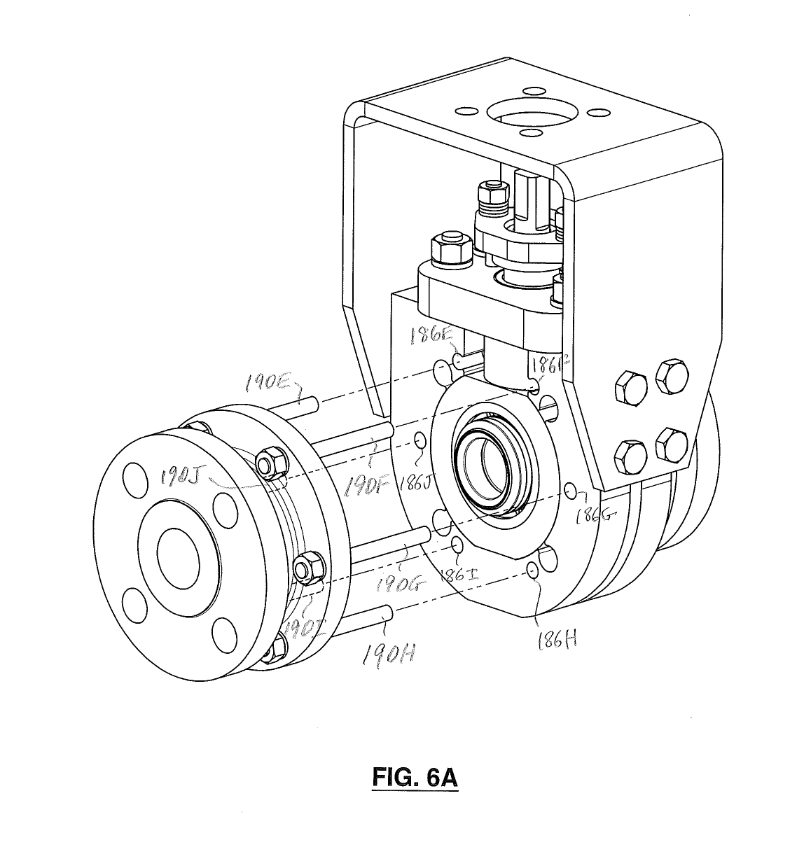

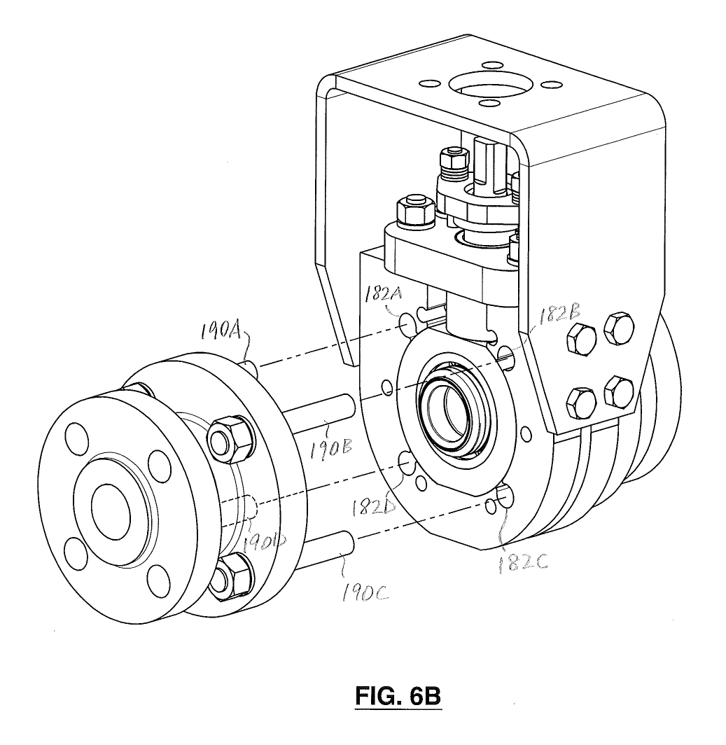

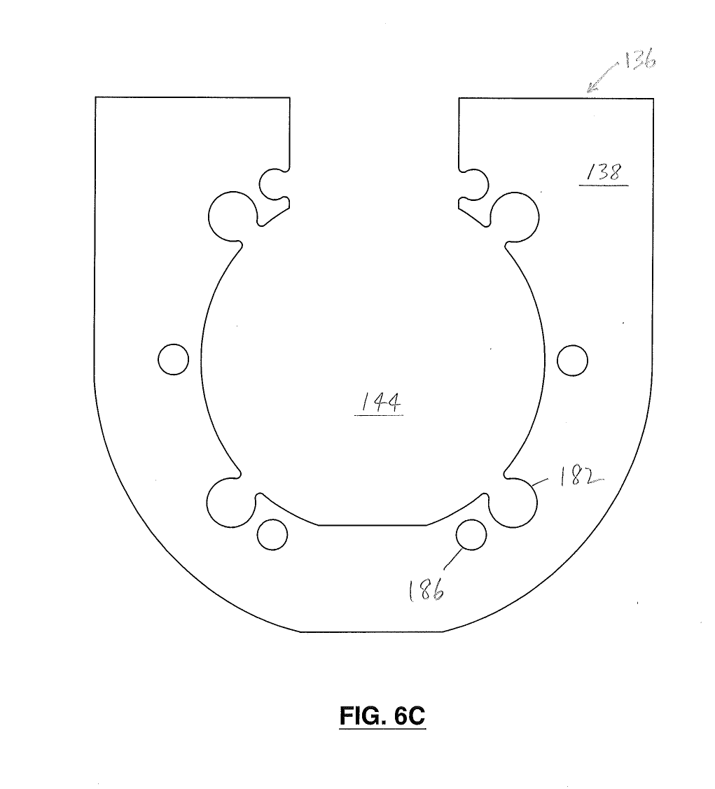

In the attached drawings, like reference numerals designate corresponding elements throughout. To simplify the description, the numerals used previously in describing FIGS. 1A-1C will be used again after increasing the numerals by 100 (or multiples thereof), where the parts to be described correspond to parts already described. Reference is first made to FIGS. 2A-5B to describe an embodiment of a valve assembly in accordance with the invention indicated generally by the numeral 130. As will be described, the valve assembly 130 is for controlling flow of a fluid therethrough. In one embodiment, the valve assembly 130 preferably includes a first flange 132 and a second flange 134 and two or more plates 136 (FIGS. 5C, 6C) positioned between the first flange 132 and the second flange 134. As can be seen in FIG. 5C, it is also preferred that each of the plates 136 includes a plate body 138 having an inner edge 140 that at least partially defines a part 142 of a central opening 144 therein. Preferably, the plate body 138 includes a number of apertures 146 therein for receiving respective portions 148 of a number of flange fastening elements 150 therein to secure the plate bodies 138 together between the first flange 132 and the second flange 134 to substantially align the respective inner edges 140 thereof, so that the plate bodies 138 substantially define the central opening 144 therethrough (FIGS. 2A, 2B). It is also preferred that the valve assembly 130 includes a core element 152 defining a central bore 154 therein through which the fluid is at least partially flowable, as will also be described (FIGS. 5A, 5B). Preferably, the core element 152 is formed to at least partially fit in the central opening 144.

As will also be described, it is preferred that the plate bodies 138 are made of one or more first materials and the core element is made of one or more second materials that are selected for resistance to corrosion thereof by the fluid.

Those skilled in the art would appreciate that the valve may be configured to control the flow of various fluids. The fluid may be one or more liquids, and/or one or more gases, and/or liquid(s) and gas(es). In addition, for the purposes hereof, the “fluid” is understood to also refer to one or more fluids, as noted above, and/or solids carried by the liquid(s) and or gases, e.g., a slurry. For example, in FIG. 2A, arrow “A” indicates a direction in which fluid in a pipe (not shown) controlled by the valve assembly may flow. (Those skilled in the art would appreciate that, depending on the circumstances, the fluid may alternatively flow in an opposite direction, or it may flow in each direction at different times.)

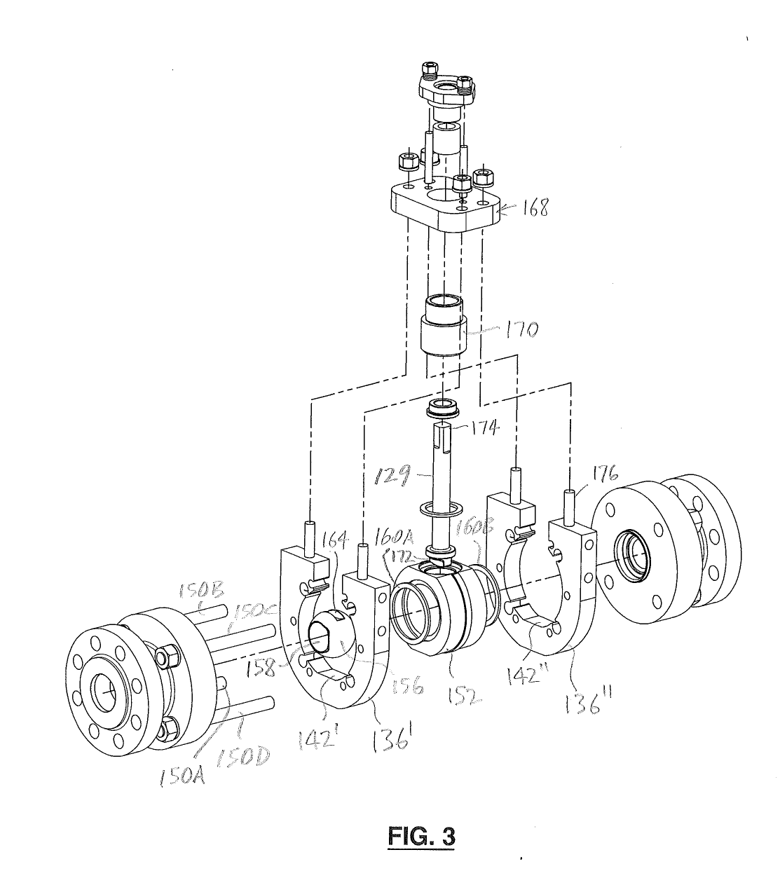

In FIGS. 2A and 3, the two plates illustrated are identified as 136′ and 136″ for convenience. It will be understood that more than two plates may be used in one valve assembly. It will also be understood that, in FIG. 2B, the valve assembly 130 of FIG. 2A is illustrated with the plates 136′, 136″ omitted, for clarity of illustration.

As can be seen, for example, in FIG. 3, in one embodiment, the plates 136′, 136″ are positioned between the first and second flanges 132, 134. It can also be seen in FIGS. 3, 5A, and 5B that the core element 152 fits in the central opening 144, which is defined by the respective inner edges 140′, 140″ of the respective plate bodies 138′, 138″ of the plates 136′, 136″ (FIGS. 5C, 6C). Each of the inner edges 140′, 140″ at least partially defines respective parts 142′, 142″ that form the central opening 144 (FIGS. 5C, 6C).

The plates 136′, 136″ and the flanges 132, 134 preferably are fastened together by the flange fastening elements 150. Those skilled in the art would appreciate that various arrangements may be used. For instance, as illustrated in FIG. 3, four flange fastening elements (identified in FIG. 3 by reference numerals 150A, 150B, 150C, and 150D for convenience) may be used.

Other parts of the valve assembly 130 can also be seen in FIG. 3. For example, in one embodiment, the valve assembly 130 preferably includes a ball 156 having a port 158 therein for positioning in the central bore 154. Preferably, the valve assembly 130 also includes gaskets or seals identified by reference numerals 160A, 160B for convenience. The gaskets 160A, 160B provide seals between the flanges 132, 134 and the core element 152 respectively (FIG. 3).

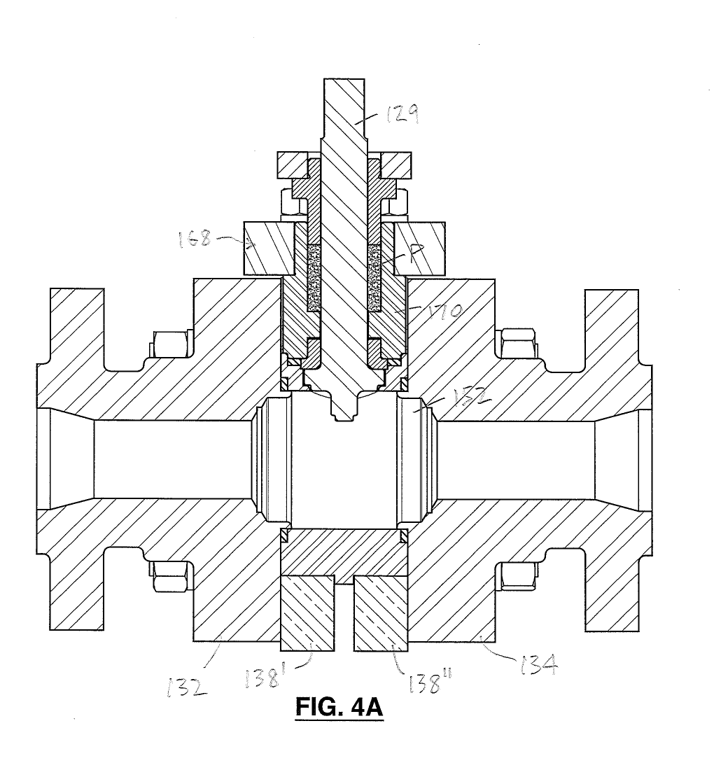

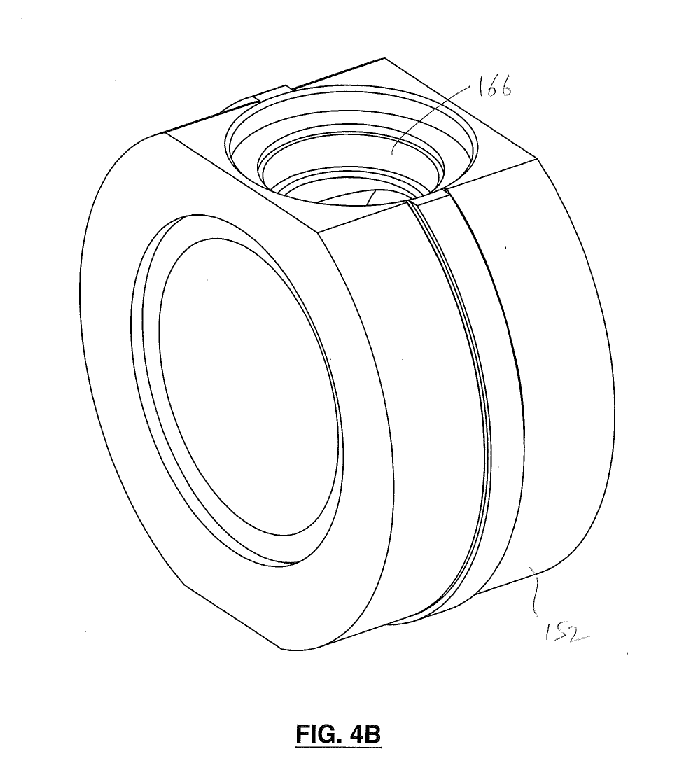

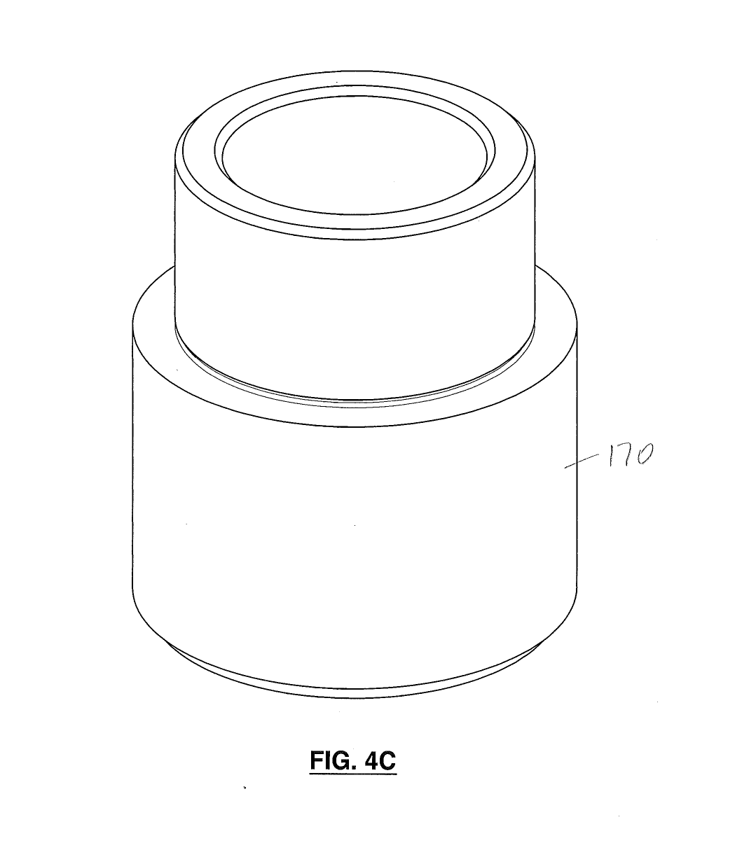

Preferably, an elongate actuator 129 is formed to engage the ball 156 at a slot 164 in the ball 156. As can be seen in FIG. 3, the actuator 129 preferably is positioned to extend through an opening 166 (FIG. 4B) in the core element 152 to engage the ball 156. As will be described, the valve assembly 130 preferably also includes a bonnet plate 168 and a bonnet adaptor 170 positioned between the core element 152 and the bonnet plate 168. The actuator 129 preferably extends between inner and outer ends 172, 174 thereof. Those skilled in the art would appreciate that, in use, the outer end 174 of the actuator 129 preferably is engaged by a handle or other device to permit rotation thereof as required, to move the ball 156 and to thereby control flow of the fluid through the central bore 154.

It is also preferred that the bonnet plate 168 is fastened to the plate bodies 138′, 138″ by a number of bonnet fastening elements 176. Those skilled in the art would be aware of suitable arrangements. As can be seen in FIG. 3, each of the bonnet fastening elements 176 preferably includes a bolt and a nut. Preferably, and as can be seen in FIG. 5D, the bonnet plate 168 includes a bonnet plate body 178 defining a channel 180 therein for receiving a part of the actuator 129 therein, to control flow of the fluid through the central bore 154. It is also preferred that the bonnet plate 168 is made of the first material(s). As can be seen in FIG. 4A, packing “P” is positioned around the actuator 129 as required. Because the control of the ball 156 via the actuator 129 and positioning seals and packing around the actuator are well known in the art, it is not necessary that they be described in further detail herein.

As can be seen in FIGS. 5A and 5B, the apertures 146 in each of the plate bodies 138 preferably include at least a first set of first apertures 182, each first aperture 182 having approximately a preselected first diameter 184. It is also preferred that the apertures 146 include at least a second set of second apertures 186, each second aperture 186 having approximately a preselected second diameter 188, the first and second diameters being unequal, for receiving flange fastening elements 190 having corresponding different diameters thereof respectively.

For instance, in FIG. 5B, the first apertures 182 are illustrated as each having the diameter 184, and the second apertures 186 are illustrated as each having the smaller diameter 188.

In FIG. 6B, for clarity of illustration, the flange fastening elements are identified by reference numerals 190A-190D respectively, and the corresponding first apertures therefore are identified by reference numerals 182A-182D respectively. As can be seen in FIG. 6B, the flange fastening elements 190A-190D are receivable in the first apertures 182A-182D respectively. As can be seen in FIG. 6A, other flange fastening elements 190E-190J are receivable in the second apertures 186A-186J respectively. The diameters of the flange fastening elements 190A-190D are larger than the diameters of the flange fastening elements 190E-190J.

Those skilled in the art would appreciate that the ability to use differently-sized flange fastening elements with the same plates is advantageous, as it reduces manufacturing costs.

As can be seen in FIG. 2A, the bonnet plate body 178 preferably is secured to the plate bodies 138′, 138″ by bonnet fastening elements 192. Preferably, and as can be seen in FIGS. 3 and 5D, the bonnet plate body 178 includes a number of bonnet plate holes 196 therein, for receiving at least parts of the bonnet fastening elements 192 respectively. Preferably, the bonnet plate body 178 is positioned on the plate bodies 138′, 138″, to substantially align the bonnet plate holes 196 with corresponding plate holes 198 (FIG. 5C) in the plate bodies 138′, 138″.

The bonnet fastening elements 192 preferably are inserted through the bonnet plate holes 196 and into the plate holes 198, and, using the bonnet fastening elements 192, the bonnet plate body 178 is secured to the plate bodies 138′, 138″.

As can be seen in FIGS. 5A and 5D, in one embodiment, the bonnet plate 168 preferably includes holes 127 in which fasteners “F₁” are at least partially receivable, for securing a gland adjustment plate 128 around the actuator 129 and compressing the stem packing

In one embodiment, the invention provides a method of assembling the valve assembly 130. Preferably, the method includes providing the first flange 132 and the second flange 134, and providing two or more plates 136. The two plates 136′, 136″ are positioned between the first and second flanges 132, 134. The apertures 182, 186 in the plate bodies 138′, 138″ preferably are substantially aligned respectively, and the respective inner edges 140′, 140″ of the plate bodies 138′, 138″ are substantially aligned to at least partially define the central opening 144.

The core element 152 is provided, sized to fit at least partially in the central opening 144. The core element 152 defines the bore 154 therein through which the fluid is flowable. The core element 152 is positioned substantially in the central opening 144. Using flange fastening elements 150, the plate bodies 138′, 138″ are secured between the first and second flanges 132, 134.

In one embodiment, the method also includes providing the bonnet plate 168. As described above, the bonnet plate 168 preferably includes the bonnet plate body 178, which has a number of the bonnet plate holes 196 therein for at least partially receiving the bonnet plate fasteners 176. The bonnet plate 168 is positioned on the plates 136′, 136″ to substantially align the bonnet plate holes 196 therein with corresponding plate holes 198 respectively in the plates 136′, 136″. The bonnet fastening elements 192 are at least partially inserted through the bonnet plate holes 196 and into the plate holes 198. The bonnet fastening elements 192 are used to secure the bonnet plate 168 to the plates 136′, 136″.

Those skilled in the art would appreciate that, for many of the steps of the methods of the invention, the order in which such steps are performed is not important. For example, the order in which the plates and the flanges are provided is unimportant.

From the foregoing, it can be seen that the valve assembly of the invention that requires significantly less material than the valves of the prior art. In addition, the valve assembly of the invention may be constructed to minimize the quantities of relatively expensive specialty materials (e.g., highly corrosion-resistant materials) that are required. Also, because the plate bodies include sets of apertures for receiving fasteners of different diameters, various fastening elements may be used, to minimize manufacturing costs.

It will also be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A valve assembly for controlling flow of a fluid therethrough, the valve assembly comprising:
a first flange and a second flange;
at least two plates positioned between the first flange and the second flange, each said plate comprising:
a plate body comprising an inner edge at least partially defining a part of a central opening therein;
the plate body comprising a plurality of apertures therein for receiving respective portions of a plurality of flange fastening elements therein to secure said at least two plate bodies together between the first flange and the second flange to substantially align the respective inner edges thereof, such that said at least two plate bodies substantially define the central opening therethrough; and
a core element defining a central bore therein through which the fluid is at least partially flowable, the core element being formed to at least partially fit in the central opening.

2. A valve assembly according to claim 1 in which said at least two plate bodies comprise at least one first material and the core element comprises at least one second material that is selected for resistance to corrosion thereof by the fluid.

3. A valve assembly according to claim 1 additionally comprising a bonnet plate fastened to said at least two plate bodies by a plurality of bonnet fastening elements, the bonnet plate comprising a bonnet plate body defining a channel therein for receiving an actuator therein, to control flow of the fluid through the central bore.

4. A valve assembly according to claim 1 in which the bonnet plate comprises said at least one first material.

5. A valve assembly according to claim 1 in which the plurality of apertures in each said plate body comprises at least a first set of first apertures, each said first aperture having approximately a preselected first diameter, and at least a second set of second apertures, each said second aperture having approximately a preselected second diameter, the first and second diameters being unequal, for receiving flange fastening elements having corresponding different diameters thereof respectively.

6. A method of assembling a valve assembly for controlling flow of a fluid therethrough, the method comprising:
(a) providing a first flange and a second flange;
(b) providing at least two plates, each said plate comprising:
a plate body comprising an inner edge at least partially defining a part of a central opening in the plate body;
the plate body comprising a plurality of apertures therein for receiving respective portions of a plurality of flange fastening elements therein to secure said at least two plate bodies together between the first flange and the second flange to substantially align the respective inner edges thereof, such that said at least two plate bodies substantially define the central opening therethrough;
(c) positioning said at least two plates between the first and second flanges;
(d) aligning the apertures in the plate bodies and aligning the inner edges thereof to at least partially define the central opening;
(e) providing a core element sized to fit at least partially in the central opening, the core element defining a bore therein through which the fluid is flowable;
(f) positioning the core element substantially in the central opening; and
(g) using the fastening elements to secure said at least two plate bodies between the first and second flanges.

7. A method according to claim 6 in which said at least two plate bodies comprise at least one first material and the core element comprises at least one second material that is selected for resistance to corrosion thereof by the fluid.

8. A method according to claim 6 additionally comprising:
(h) providing a bonnet plate comprising a bonnet plate body having a plurality of bonnet plate holes therein for at least partially receiving bonnet fastening elements;
(i) positioning the bonnet plate on said at least two plates to substantially align the bonnet plate holes therein with corresponding plate holes in said at least two plates;
(j) inserting the bonnet fastening elements through the bonnet plate holes and into the plate holes; and
(k) using the bonnet fastening elements to secure the bonnet plate to said at least two plates.
